(19) United States
(12) Patent Application Publication
(10) Pub. No.: US 2012/0127208 A1
(43) Pub. Date: May 24, 2012

(54) METHOD FOR SCROLLING SCREEN IN TOUCH SCREEN TERMINAL AND DEVICE THEREOF

(75) Inventors: Dae-Young Jo, Suwon-si (KR); Jong-Woo Choi, Suwon-si (KR); Won-Hyung Heo, Gimpo-si (KR)

(73) Assignee: SAMSUNG ELECTRONICS CO., LTD., Suwon-si (KR)

(21) Appl. No.: 13/301,536

(22) Filed: Nov. 21, 2011

(30) Foreign Application Priority Data
Nov. 22, 2010 (KR) 10-2010-0116318

(51) Int. Cl. G09G 5/00; G06F 3/041

(52) U.S. Cl. 345/684

(57) ABSTRACT

A method and apparatus scroll a screen in a touch screen terminal. The method includes entering a screen scroll mode, determining the direction of screen scroll, preparing screen scroll of the determined direction, and waiting to receive a screen scroll signal for operating the screen scroll, and, if the screen scroll signal is received, performing the screen scroll in the previously determined direction.

### CROSS-REFERENCE TO RELATED APPLICATION AND CLAIM OF PRIORITY

The present application is related to and claims priority under 35 U.S.C. §119(a) to a Korean Patent Application filed in the Korean Intellectual Property Office on Nov. 22, 2010 and assigned Serial No. 10-2010-0116318, the contents of which are herein incorporated by reference.

### TECHNICAL FIELD OF THE INVENTION

The present invention relates to a touch screen terminal. More particularly, the present invention relates to a method and apparatus facilitating screen scroll in a touch screen terminal.

### BACKGROUND OF THE INVENTION

Currently, owing to the development of the electronic communication industry, portable terminals such as mobile communication terminals, electronic notes, Personal Digital Assistants (PDAs) and the like are becoming necessities to a modern society while becoming an important means for delivery of fast changing information.

As widely known, recently, a portable terminal applies a touch screen in which an input is induced if a touch occurs on the touch screen. The touch screen is a screen equipped with an input device for, when a touch occurs by hand, receiving an input of its position. The convenience of the touch screen results in users' satisfaction. Further, to keep pace with an information society, various contents a web page, an electronic book and the like) are flooding, and terminals capable of reading these contents are in mass production. In these circumstances, users' desires for terminals are growing up, and an overload for satisfying these desires is followed. For one example, in a case where a user is to read a web page from a terminal applying a touch screen (hereinafter, referred to as a ‘touch screen terminal’), the user scrolls the screen to view contents not seen on the screen by touch and flicking. But, in some cases, the moment the user touches to scroll the screen, an unintended link web page is opened. Further, in a case where the number of scrolling the screen is large, the user should do a touch and flicking frequently.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to substantially solve at least the above problems and/or disadvantages and to provide at least the advantages below. Accordingly, one aspect of the present invention is to provide a method and apparatus facilitating screen scroll in a touch screen terminal.

Another aspect of the present disclosure is to provide a method and apparatus for determining the direction of screen scroll and, if a corresponding signal is generated, scrolling a screen in the determined direction in a touch screen terminal.

A further aspect of the present disclosure is to provide a method and apparatus for determining the direction of screen scroll by a touch and move and, if a signal is generated in a proximity sensor, scrolling a screen in the determined direction in a touch screen terminal with the proximity sensor.

The above aspects are achieved by providing a method and apparatus for scrolling a screen in a touch screen terminal.

In accordance with an aspect of the present disclosure, a method for screen scroll in a touch screen terminal is provided. The method includes entering a screen scroll mode, determining the direction of screen scroll, preparing screen scroll of the determined direction, and waiting to receive a screen scroll signal for operating the screen scroll, and, if the screen scroll signal is received, performing the screen scroll in the previously determined direction.

In accordance with another aspect of the present disclosure, an apparatus for screen scroll in a touch screen terminal is provided. The apparatus includes a controller for entering a screen scroll mode, determining the direction of screen scroll, preparing screen scroll of the determined direction and, if a screen scroll signal is received, performing the screen scroll in the previously determined direction.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a touch screen terminal according to an exemplary embodiment of the present disclosure;

FIG. 2 illustrates a block diagram of a touch screen terminal according to an exemplary embodiment of the present disclosure;

FIG. 3 illustrates a method of screen scroll in a touch screen terminal according to an exemplary embodiment of the present disclosure; and

FIGS. 4A to 4D illustrate processes of screen scroll in a touch screen terminal with a proximity sensor.

### DETAILED DESCRIPTION OF THE INVENTION

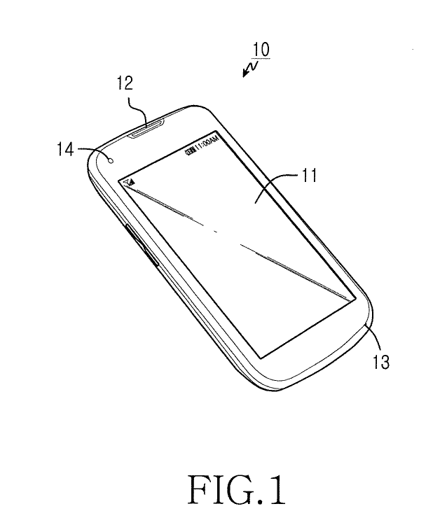

FIGS. 1 through 4D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged computing device. Preferred embodiments of the present invention will be described herein below with reference to the accompanying drawings. In the following description, well-known functions or constructions are not described in detail since they would obscure the invention in unnecessary detail. And, terms described below, which are defined considering functions in the present invention, can be different depending on user and operator's intention or practice. Therefore, the terms should be defined on the basis of the disclosure throughout this specification.

FIG. 1 illustrates a touch screen terminal according to an exemplary embodiment of the present disclosure.

Referring to FIG. 1, the touch screen terminal 10 can be a Personal Digital Assistant (PDA), a cellular phone and the like. The touch screen terminal 10 includes a touch screen 11 for outputting an image signal and inputting data, a speaker 12 for outputting a voice signal, and a microphone 13 for inputting a voice signal.

The touch screen 11 is composed of a display (e.g., a Liquid Crystal Display (LCD)) having millions of pixels, and a touch panel mounted in the display. The touch screen 11 is widely known in the art and thus, its detailed description is omitted.

Further, the touch screen terminal 10 has a proximity sensor 14. If the proximity sensor 14 senses that an object approaches, the proximity sensor 14 outputs a signal. Generally, the use of the proximity sensor 14 can lead to a decrease of the power consumption of a terminal. For one example, if a user gets the terminal proximal to his/her ear for a call, the proximity sensor 14 outputs a signal according to object approaching and, according to this signal, the touch screen terminal 10 may Off a picture of the touch screen 11.

Particularly, when reading contents such as a web page, an electronic book and the like, the touch screen terminal 10 determines the direction of screen scroll using the touch screen 11. If a signal is output from the proximity sensor 14, the touch screen terminal 10 performs screen scroll in the previously determined direction. This is described below in detail with reference to the drawings.

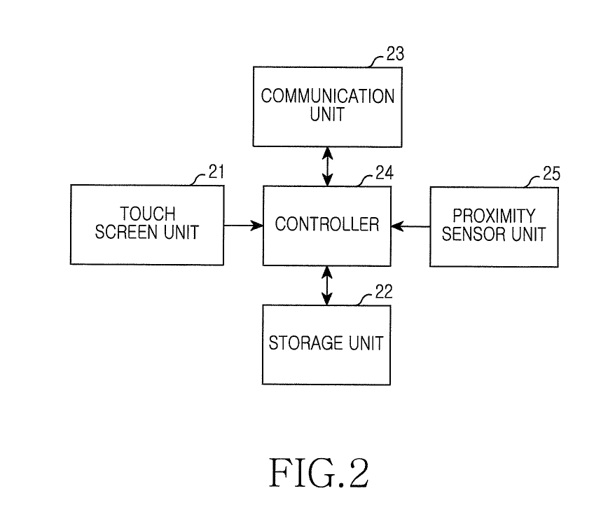

FIG. 2 illustrates a block diagram a touch screen terminal according to an exemplary embodiment of the present disclosure.

Referring to FIG. 2, the touch screen terminal includes a touch screen unit 21 for input/output, a storage unit 22 for data storage, a communication unit 23 for communication, a controller 24 for performing the control of general operation, and a proximity sensor unit 25 for, if an object approaches, outputting a signal.

The touch screen unit 21 outputs an input signal resulting from a touch to the controller 24. According to the control of the controller 24, the touch screen unit 21 receives and displays display data corresponding to the input signal. The storage unit 22 stores a predetermined program controlling a general operation of the touch screen terminal and various data being, input/output when a control operation of the touch screen terminal is performed. Under the control of the controller 24, the communication unit 23 performs wired or wireless communication. The controller 24 controls the general operation of the touch screen terminal. A screen scroll method of the controller 24 according to an exemplary embodiment of the present disclosure is described below in detail with reference to the drawings.

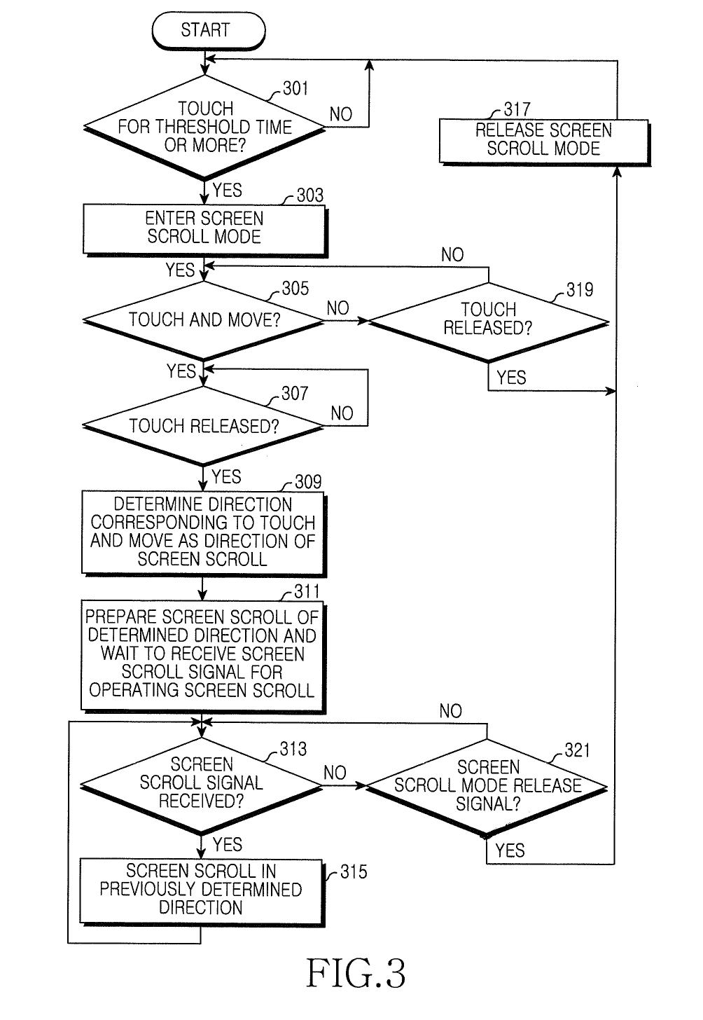

FIG. 3 illustrates a method of screen scroll in a touch screen terminal according to an exemplary embodiment of the present disclosure. A description of FIG. 3 is made assuming that the touch screen terminal is reading contents such as a web page, an electronic book and the like.

Referring to FIG. 3, in step 301, the controller 24 identifies if a touch occurs for a threshold time or more on the touch screen unit 21.

If the touch occurs for the threshold time or more, the controller 24 proceeds to step 303 and enters a screen scroll mode.

After that, in step 305, the controller 24 identifies a touch and move. If the controller identifies a state where the touch and move is not identified and only the touch is done for the threshold time or more, the controller 24 proceeds to step 319 and identifies a touch release. If the touch release is identified in step 319, the controller 24 proceeds to step 317 and releases (i.e., terminates) the screen scroll mode.

If the touch and move is identified in step 305, in step 307, the controller 24 identifies if the touch is released. If the touch is released after the touch and move, the controller 24 proceeds to step 309 and determines a direction corresponding to the touch and move, as the direction of screen scroll. Next, the controller 24 proceeds to step 311 and prepares screen scroll of the previously determined direction, waiting to receive a screen scroll signal for operating the screen scroll.

If the controller identifies in step 313 that a screen scroll signal is received, the controller 24 proceeds to step 315 and performs the screen scroll of the previously determined direction. The screen scroll signal may be generated from a separate key button provided in the touch screen terminal. Further, the screen scroll signal may be induced from the proximity sensor unit 25. For one example, the proximity sensor unit 25 senses that an object approaches, and outputs a signal for this to the controller 24. If receiving the signal from the proximity sensor unit 25, the controller 24 performs screen scroll. Further, if the screen scroll signal is continuous, the controller 24 may perform continuous screen scroll in the previously determined direction.

Also, in step 321, the controller 24 identifies if a screen scroll mode release signal is generated in the course of waiting to receive a screen scroll signal. If the controller identifies in step 321 that the screen scroll mode release signal is generated, the controller 24 proceeds to step 317 and releases (i.e., terminates) the screen scroll mode. The screen scroll mode release signal can be generated if an unspecific region of a touch screen is touched.

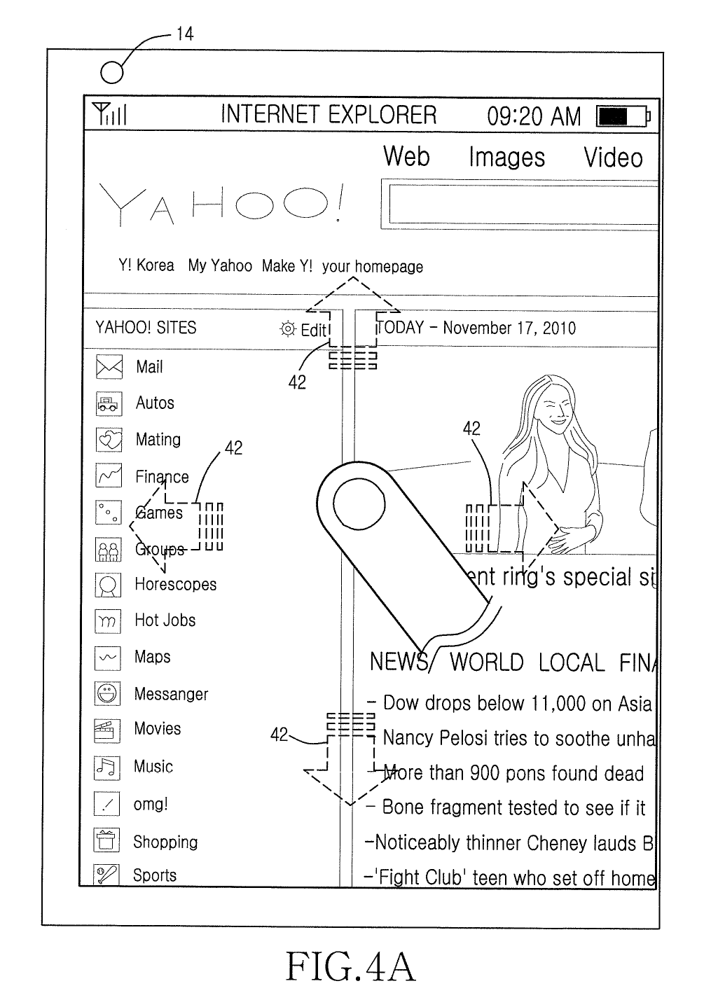

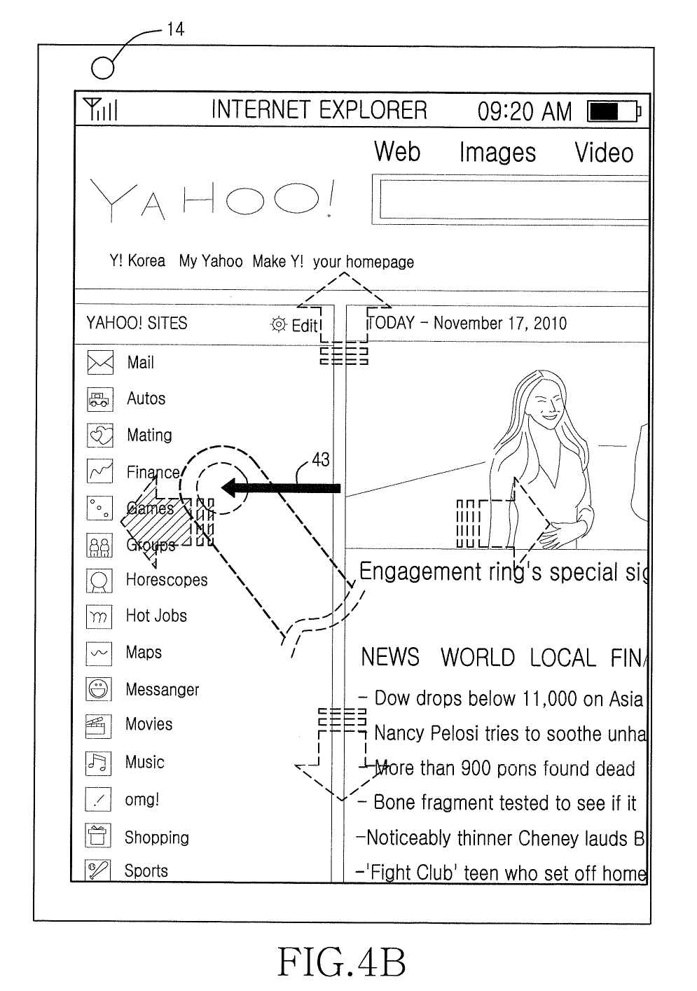

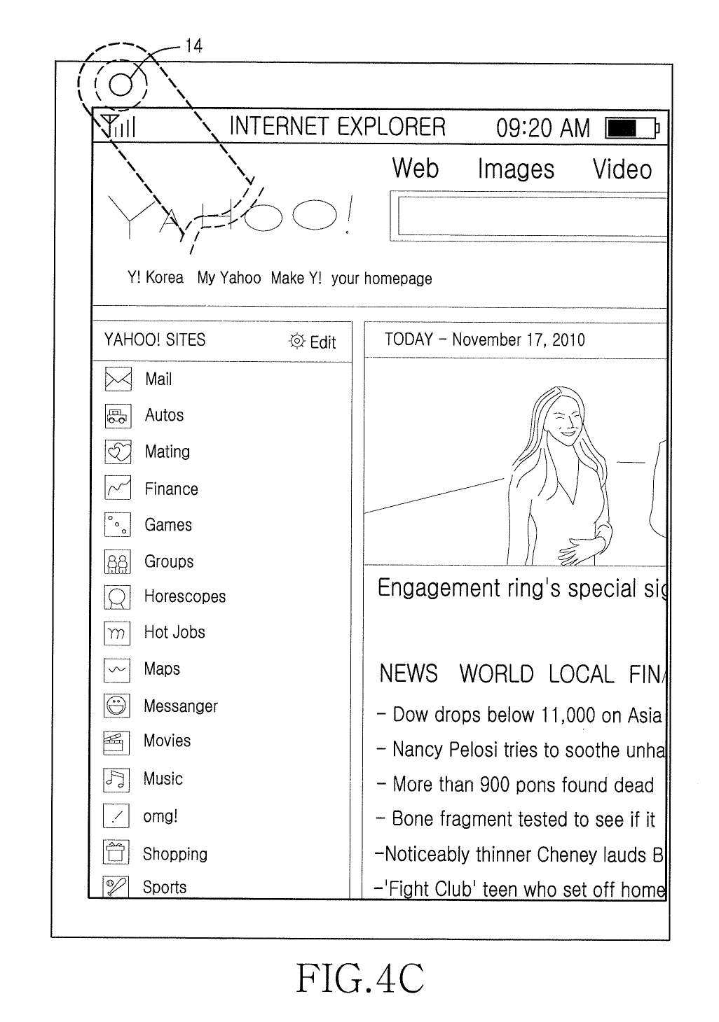

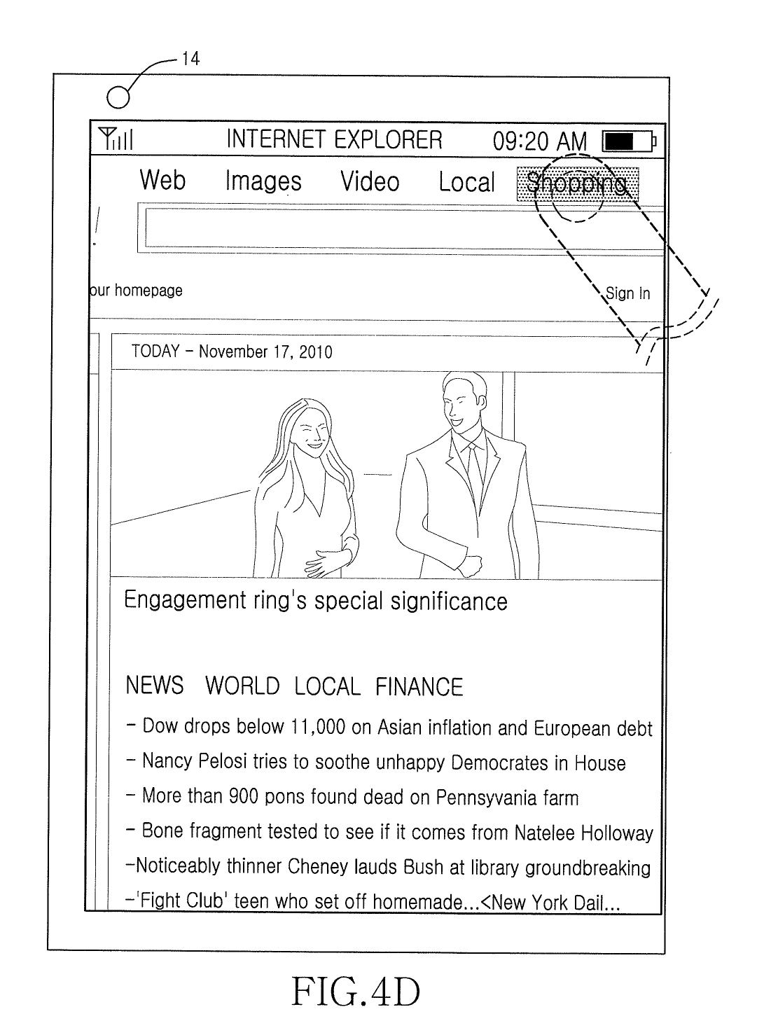

FIGS. 4A to 4D illustrate processes of screen scroll in a touch screen terminal with a proximity sensor. As illustrated in FIGS. 4A to 4C, the touch screen terminal is outputting contents such as a web page, an electronic book and the like.

In FIG. 4A, a screen scroll mode is executed if a user touches an unspecific touch region of a touch screen for a threshold time or more. The screen scroll mode displays arrows 42 for guiding up/down/left/right directions in which a screen is scrolled.

In FIG. 4B, after touching for the threshold time or more, if the user touches and moves in a left direction and releases the touch (43), the screen scroll mode determines the direction of screen scroll as the left, prepares screen scroll of the left direction, and waits to receive a signal for operating the screen scroll of the left direction. If the user touches and moves in a corresponding direction, the screen scroll mode expresses an arrow of the corresponding direction as noticeable to let the user know the direction of screen scroll to be implemented in future. As illustrated, the screen scroll can be performed in four directions of up/down/left/right but, without being limited to this, can be performed in various directions. For one example, the direction of screen scroll can be a direction from a touch starting point to a touch ending point. If the touch is released without a touch and move, the arrows disappear and the screen scroll mode is released.

In FIG. 4C, the user generates a screen scroll signal for operating the prepared screen scroll of the left direction. The screen scroll signal can be output from a proximity sensor 14 of a terminal. For one example, if the user gets a finger proximal to the proximity sensor 14, the proximity sensor 14 senses that an object approaches, and outputs the screen scroll signal. As aforementioned, if the screen scroll signal is output continuously, continuous screen scroll is performed in a corresponding direction. For one example, if the user gets a finger proximal to the proximal sensor 14 for a threshold time or more, continuous screen scroll is performed in a corresponding direction. Further, the screen scroll mode may construct a separate touch button for the screen scroll start signal in a touch area.

In FIG. 4D, if an unspecific area is touched, the screen scroll mode is released and, according to cases, a corresponding link page can be immediately opened. For one example, if a user touches a touch area where a ‘Shopping’ link is displayed in course of the screen scroll mode, the screen scroll mode is released and the display converts into a ‘Shopping’ link page.

A method and apparatus for screen scroll in a touch screen terminal according to the present disclosure can prevent an unintended operation caused by an erroneous touch at screen scrolling.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for screen scroll in a touch screen terminal, the method comprising:
entering a screen scroll mode;
determining a direction of the screen scroll;
preparing the screen scroll of the determined direction, and waiting to receive a screen scroll signal for operating the screen scroll; and
responsive to receiving the screen scroll signal, performing the screen scroll in the determined direction.

2. The method of claim 1, wherein entering the screen scroll mode comprises:
starting the screen scroll mode in response to detecting a touch in an unspecific touch region for at least a threshold time.

3. The method of claim 1, wherein determining the direction of the screen scroll comprises:
sensing a touch and move, and determining a direction corresponding to the sensed touch and move as the direction of the screen scroll.

4. The method of claim 3, wherein determining the direction of the screen scroll further comprises:
determining a direction from a touch starting point to a touch ending point as the direction of the screen scroll.

5. The method of claim 3, wherein determining the direction of the screen scroll further comprises:
displaying arrows for guiding at least one or more directions; and
selecting one arrow by the touch and move, and determining a direction corresponding to the selected arrow as the direction of the screen scroll.

6. The method of claim 1 further comprising:
responsive to continuously receiving the screen scroll signal, continuously performing the screen scroll in the determined direction.

7. The method of claim 1 further comprising:
responsive to a screen scroll mode release signal being generated, terminating the screen scroll mode.

8. The method of claim 7, wherein the scroll mode release signal is output if an unspecific touch area is touched.

9. The method of claim 1, wherein the screen scroll signal is output from a device other than a touch screen.

10. The method of claim 9, wherein the device other than the touch screen is a proximity sensor.

11. An apparatus for screen scroll in a touch screen terminal, the apparatus comprising:
a controller configured to enter a screen scroll mode, determine a direction of the screen scroll, prepare the screen scroll of the determined direction, and perform, responsive to receiving a screen scroll signal, the screen scroll in the determined direction.

12. The apparatus of claim 11, wherein the controller is further configured to enter the screen scroll mode in response to detecting an unspecific touch region being touched for at least a threshold time.

13. The apparatus of claim 11, wherein the controller is further configured to sense a touch and move, and determine a direction corresponding to the sensed touch and move as the direction of the screen scroll.

14. The apparatus of claim 13, wherein the controller is further configured to determine a direction from a touch starting point to a touch ending point as the direction of the screen scroll.

15. The apparatus of claim 13, wherein the controller is further configured to display arrows for guiding at least one or more directions and determine, responsive to one arrow being selected by the touch and move, a direction corresponding to the selected arrow as the direction of the screen scroll.

16. The apparatus of claim 11, wherein, responsive to the screen scroll signal being continuously received, the controller is further configured to continuously perform the screen scroll in the previously determined direction.

17. The apparatus of claim 11, wherein, responsive to a screen scroll mode release signal being generated, the controller is further configured to terminate the screen scroll mode.

18. The apparatus of claim 17, wherein the scroll mode release signal is output if an unspecific touch area is touched.

19. The apparatus of claim 1, wherein the screen scroll signal is output from a device other than a touch screen.

20. The apparatus of claim 19, wherein the device other than the touch screen is a proximity sensor.
